(19) United States
(12) Patent Application Publication
(10) Pub. No.: US 2016/0079691 A1
(43) Pub. Date: Mar. 17, 2016

(54) CONDUCTIVE PIN STRUCTURE AND ELECTRICAL CONNECTOR HAVING THE CONDUCTIVE PIN STRUCTURE

(71) Applicant: ALL BEST PRECISION TECHNOLOGY CO., LTD., Taoyuan County (TW)

(72) Inventor: HAVEN YANG, New Taipei City (TW)

(21) Appl. No.: 14/489,243

(22) Filed: Sep. 17, 2014

(51) Int. Cl. H01R 12/57; H01R 24/60

(52) U.S. Cl. CPC H01R 12/57; H01R 24/60; H01R 2107/00

(57) ABSTRACT

A conductive pin structure includes a frame and a plurality of conductive pins. The conductive pins are arranged transversely, spaced apart, disposed on two sides of the frame longitudinally, insertedly, and fixedly, passing through a hollow-core region of the frame, and each having a resilient electrical contact segment and an electrical connection segment connected thereto. An electrical connector includes two conductive pin structures and a casing; the frames are connected to each other, whereas the casing has a forward-facing plug inlet and receives the conductive pin structures in a manner that the resilient electrical contact segments point at the plug inlet and terminal portions of the electrical connection segments are exposed from the casing. Hence, the conductive pin structure and the electrical connector are capable of adjusting impedance, reducing signal loss, simplifying die structures, extending the service life of dies, speeding up processing work, and streamlining processing work.

### FIELD OF THE INVENTION

The present invention relates to conductive pin structures and electrical connectors having the conductive pin structures, and more particularly, to a conductive pin structure and an electrical connector having the conductive pin structures, capable of adjusting impedance, reducing signal loss, simplifying die structures, extending the service life of dies, speeding up processing work, and streamlining processing work.

### BACKGROUND OF THE INVENTION

Due to information explosion, remote data is mostly transmitted with wireless transmission devices, whereas local data is mostly transmitted with electrical connectors. In general, conductive pins of conventional electrical connectors are disposed therein by insert molding, for example, either enclosing the conductive pins in part, or enclosing some conductive pins and then exposing some other conductive pins. However, the technique of enclosing the conductive pins in part has a disadvantage, that is, a plastic structure connected to conductive pins increases signal loss and prevent adjustment of impedance. The technique of enclosing some conductive pins and then exposing some other conductive pins has a disadvantage, that is, conductive pins are partially covered with a plastic structure, thus rendering signal loss reduction impossible. Also, to expose part of the enclosed conductive pins, it is necessary that, after the plastic structure has enclosed part of the conductive pins, part of the plastic structure must be removed with a die, thereby complicating die structures, shortening the service life of dies, slowing down processing work, and complicating processing work.

Accordingly, it is imperative to provide a conductive pin structure and an electrical connector having the conductive pin structures, capable of adjusting impedance, reducing signal loss, simplifying die structures, extending the service life of dies, speeding up processing work, and streamlining processing work.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a conductive pin structure and an electrical connector having the conductive pin structures as disclosed in the present invention with a view to adjusting impedance, reducing signal loss, simplifying die structures, extending the service life of dies, speeding up processing work, and streamlining processing work.

In order to achieve the above and other objectives, the present invention provides a conductive pin structure, comprising: a frame; and a plurality of conductive pins arranged transversely, spaced apart, disposed on two sides of the frame longitudinally, insertedly, and fixedly, passing through a hollow-core region of the frame, and each having a resilient electrical contact segment and an electrical connection segment connected to the resilient electrical contact segment.

As regards the conductive pin structure, a connection portion is disposed on one of two open sides of the frame.

As regards the conductive pin structure, the connection portion has a plurality of connecting posts or a plurality of connecting slots.

As regards the conductive pin structure, the frame is disposed at the resilient electrical contact segments or the electrical connection segments.

As regards the conductive pin structure, the frame the frame is rectangular, and the conductive pins are longitudinally, insertedly, and fixedly disposed on two long sides of the frame and pass through a hollow-core region of the frame.

In order to achieve the above and other objectives, the present invention further provides an electrical connector which comprises: the two conductive pin structures of any one of claims 1-5, wherein the frames are connected to each other; and a casing having a forward-facing plug inlet and receiving the conductive pin structures, wherein the resilient electrical contact segments of the conductive pin structures point at the plug inlet, wherein terminal portions of the electrical connection segments of the conductive pin structures are exposed from the casing.

The electrical connector further comprises a mounting unit having a plurality of slits arranged transversely, spaced apart, and adapted to receive the electrical connection segments of the conductive pin structures, respectively, wherein the mounting unit is mounted on the casing from behind, wherein terminal portions of the electrical connection segments of the conductive pin structures are exposed from the mounting unit.

As regards the electrical connector, two supporters flank the casing laterally and from behind, the supporters each having an engaging slot, wherein two engaging arms flank the mounting unit laterally and engage with the engaging slots, respectively, such that the mounting unit is fixed to the casing from behind.

As regards the electrical connector, two supporters flank the casing laterally and from behind, the supporters each having an engaging arm, wherein two engaging slots flank the mounting unit laterally and engage with the engaging arms, respectively, such that the mounting unit is fixed to the casing from behind.

As regards the electrical connector, a mounting portion is disposed at a bottom of the casing.

Therefore, a conductive pin structure and an electrical connector having the conductive pin structures, provided according to the present invention, are capable of adjusting impedance, reducing signal loss, simplifying die structures, extending the service life of dies, speeding up processing work, and streamlining processing work.

### BRIEF DESCRIPTION OF THE DRAWINGS

Objectives, features, and advantages of the present invention are hereunder illustrated with specific embodiments in conjunction with the accompanying drawings, in which:

FIG. 1 is an exploded schematic view 1 of an embodiment of the present invention;

FIG. 2 is an exploded schematic view of a conductive pin structure according to the embodiment of the present invention;

FIG. 3 is an exploded schematic view 2 of the embodiment of the present invention;

FIG. 4 is an assembled schematic view of a conductive pin structure according to the embodiment of the present invention;

FIG. 5 is an exploded schematic view 3 of the embodiment of the present invention;

FIG. 6 is an exploded schematic view 4 of the embodiment of the present invention;

FIG. 7 is an assembled schematic view of the embodiment of the present invention;

FIG. 8 is a perspective schematic view of the embodiment of the present invention, showing a frame at electrical connection segments; and

FIG. 9 is a lateral schematic view of the embodiment of the present invention, showing the frame at the electrical connection segments.

### DETAILED DESCRIPTION OF THE PREFERRED EMBODIMENTS

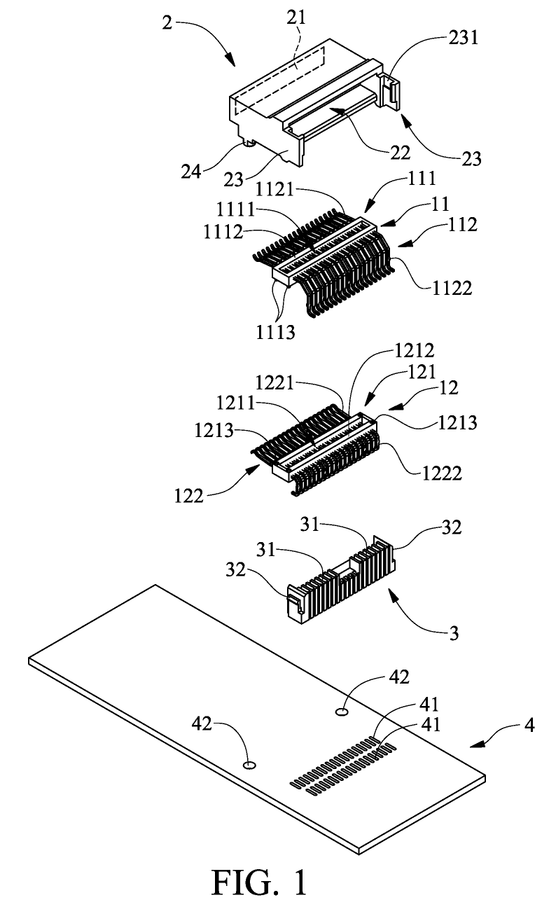

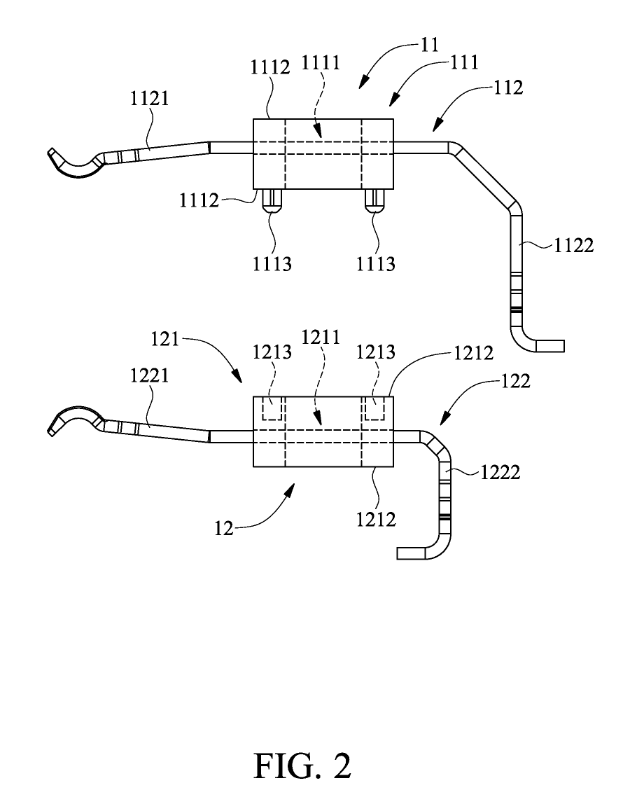

Referring to FIG. 1 and FIG. 2, the present invention provides a conductive pin structure 11 which comprises a frame 111 and a plurality of conductive pins 112. The frame 111 is made of a plastic and has a hollow-core region 1111. The conductive pins 112 are arranged transversely and spaced apart. The conductive pins 112 are longitudinally, insertedly, and fixedly disposed on two sides of the frame 111 and pass through the hollow-core region 1111 of the frame 111. The conductive pins 112 are coupled to the frame 111 by insert molding. The conductive pins 112 are disposed in an electrical connector because of the frame 111. The conductive pins 112 each have a resilient electrical contact segment 1121 and an electrical connection segment 1122 connected to the resilient electrical contact segment 1121. Referring to FIG. 2, the resilient electrical contact segment 1121 is the horizontal part of the conductive pin 112, whereas the electrical connection segment 1122 is the vertical part of the conductive pin 112. The resilient electrical contact segments 1121 are adapted to be in electrical contact with an external plug. The electrical connection segments 1122 are electrically connected to a plurality of solder pads 41 of a circuit board 4.

As regards the conductive pin structure 11, the conductive pins 112 are exposed from the hollow-core region 1111 of the frame 111, such that the conductive pin structure 11 reduces signal loss. Moreover, by resizing the hollow-core region 1111 but keeping the appearance of the frame 111 unchanged, it is practicable to alter the length of the exposed parts (in the hollow-core region 1111) of the conductive pins 112 and thus change the impedance of the conductive pins 112 to a specific impedance value. Furthermore, due to the exposed parts (in the hollow-core region 1111) of the conductive pins 112, the conductive pin structure 11 of the present invention is capable of simplifying die structures, extending the service life of dies, speeding up processing work, and streamlining processing work.

Referring to FIG. 1 and FIG. 2, a connection portion 1113 is disposed at one of two open sides 1112 of the frame 111 of the conductive pin structure 11 and connected to a connection portion 1213 of a frame 121 of the conductive pin structure 12, such that the two conductive pin structures 11, 12 are connected.

Referring to FIG. 1 and FIG. 2, a plurality of connecting posts or a plurality of connecting slots is disposed at the connection portion 1113 of the conductive pin structure 11. Hence, the frame 111 has a plurality of connecting posts whereby the frames 111, 121 are connected to each other. Alternatively, the frame 121 has a plurality of connecting slots whereby the frames 111, 121 are connected to each other. The connecting posts and connecting slots enable the frames 111, 121 to be coupled firmly to each other, because each connecting post has a cross-section slightly larger than each connecting slot, and the connecting posts are inserted into the connecting slots, respectively, under the inherent resilience of the connecting posts and/or the connecting slots to allow the connecting posts to be fixed firmly to the connecting slots, respectively.

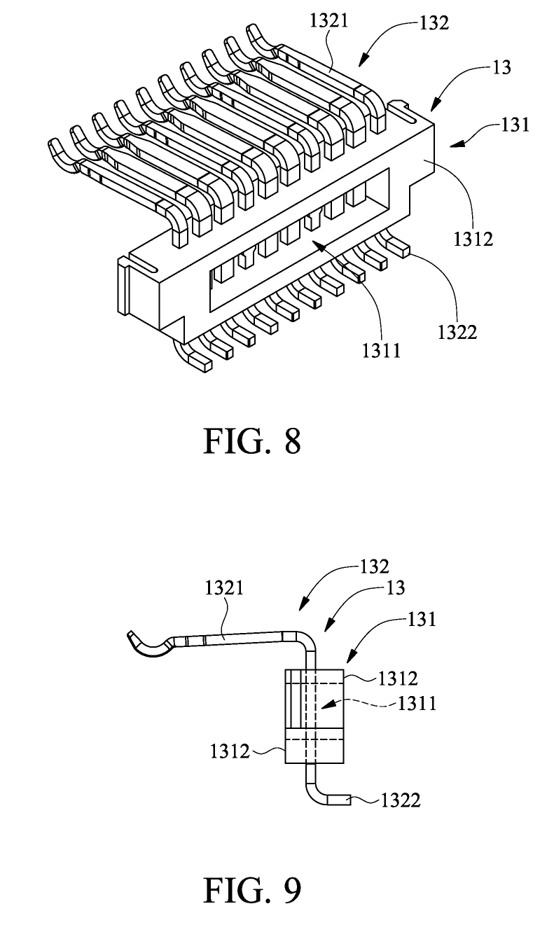

Referring to FIG. 1, FIG. 2, FIG. 8, and FIG. 9, in the conductive pin structures 11, 13, the frame 111 is disposed at the resilient electrical contact segments 1121, and a frame 131 is disposed at the electrical connection segments 1322, such that the conductive pin structure 11, 13 are applicable to electrical connectors with various structures.

Referring to FIG. 1 and FIG. 2, in the conductive pin structure 11, the frame 111 is rectangular, whereas the conductive pins 112 are longitudinally, insertedly, and fixedly disposed on two long sides of the frame 111 and pass through the hollow-core region 1111 of the frame 111. Hence, according to the present invention, it is easy to mount the conductive pin structure 11 on an electrical connector. Moreover, the connecting posts or the connecting slots are disposed at the four corners of one of the open sides 1112 of the frame 111.

Referring to FIG. 1 through FIG. 7, the present invention further provides an electrical connector which comprises the conductive pin structures 11, 12 and a casing 2. The conductive pin structures 11, 12 are connected to each other by the frames 111, 121, whereas the frames 111, 121 are connected to each other by the connection portions 1113, 1213. For example, a plurality of connecting posts is disposed on one of the open sides 1112 of the frame 111, whereas a plurality of connecting slots is disposed on one of the open sides 1212 of the frame 121. Each connecting post has a cross-section slightly larger than each connecting slot. Insertion of the connecting posts into the connecting slots, respectively, under the inherent resilience of the connecting posts and/or the connecting slots ensures that the connecting posts can be fixed firmly to the connecting slots, respectively, and in consequence the frames 111, 121 are coupled firmly to each other. Moreover, the conductive pins 112, 122 of the conductive pin structures 11, 12 can be bent to take on different shapes. After the conductive pin structures 11, 12 have been connected to each other, the resilient electrical contact segments 1121, 1221 are spaced apart vertically and arranged transversely to form a clamping opening for clamping an external plug. The electrical connection segments 1122, 1222 are spaced apart in a front-rear direction and arranged transversely to electrically connect with a plurality of solder pads 41 of a circuit board 4. A plug inlet 21 is disposed on the front of the casing 2. The casing 2 has therein a receiving channel 22 which is in communication with the plug inlet 21. The frames 111, 121 and the resilient electrical contact segments 1121, 1221 of the conductive pin structures 11, 12 are disposed in the receiving channel 22. The resilient electrical contact segments 1121, 1221 point at the plug inlet 21. Terminal portions of the electrical connection segments 1122, 1222 of the conductive pin structures 11, 12 are exposed from the casing 2 so as to electrically connect with the solder pads 41 of the circuit board 4.

As mentioned before, according to the present invention, since the conductive pins 112, 122 are exposed and thus are not enclosed by the plastic structure, the electrical connector is conducive to the reduction of signal loss. Moreover, with the frames 111, 121 being unchanged in terms of appearance and shape, the dimensions of the hollow-core regions 1111, 1211 are adjustable to alter the length of the exposed portions of the conductive pins 112, 122 within the hollow-core regions 1111, 1211, thereby adjusting impedance of the conductive pins 112, 122. Furthermore, with the conductive pins 112, 122 being exposed, the electrical connector of the present invention is capable of simplifying die structures, extending the service life of dies, speeding up processing work, and streamlining processing work.

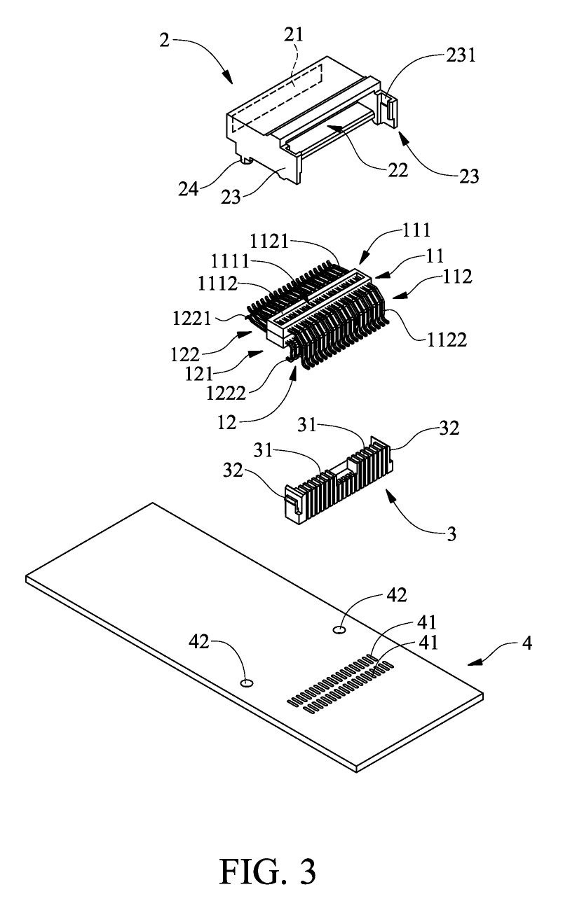

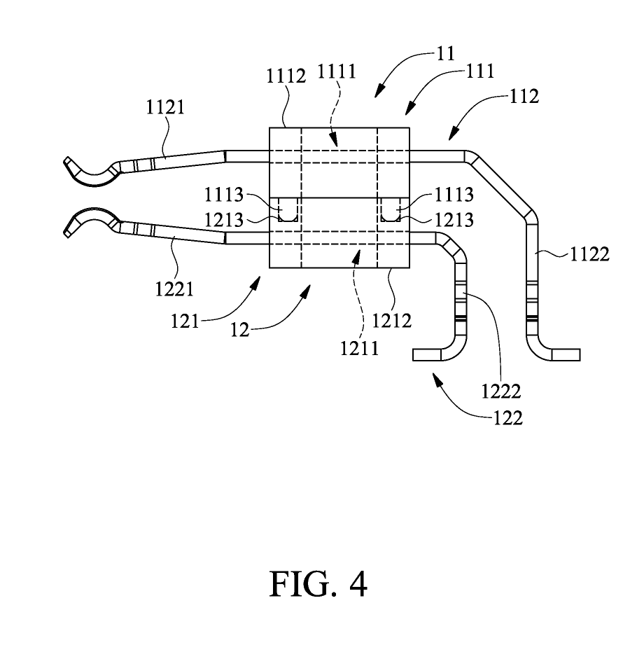

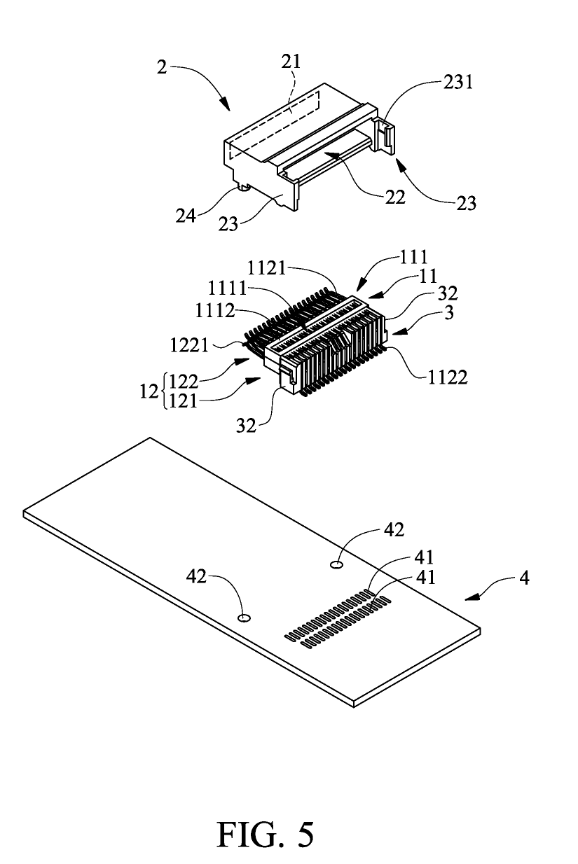

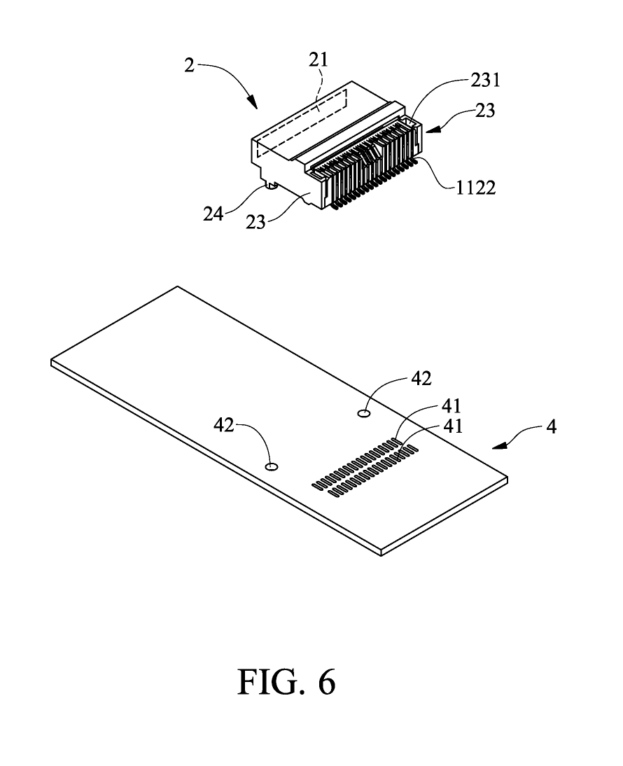

Referring to FIG. 1, FIG. 3, FIG. 4, FIG. 5, and FIG. 6, the electrical connector further comprises a mounting unit 3. The mounting unit 3 has a plurality of slits 31 arranged transversely and spaced apart. The slits 31 are each of a shape of inverted U as shown in FIG. 4, and the electrical connection segments 1122, 1222 of the conductive pin structures 11, 12 are also of a shape of inverted U each so as to be disposed in the slits 31, respectively. The mounting unit 3 is mounted on the casing 2 from behind to abut against the conductive pin structures 11, 12 and thus allow the conductive pin structures 11, 12 to be firmly disposed in the casing 2. The terminal portions of the electrical connection segments 1122, 1222 of the conductive pin structures 11, 12 are exposed from the mounting unit 3 so as to be electrically connected to the solder pads 41 of the circuit board 4.

Referring to FIG. 1, FIG. 3, FIG. 5, and FIG. 6, as regards the electrical connector, two supporters 23 (such as two supporting plates) flank the casing 2 laterally and from behind. The supporters 23 each have an engaging slot 231 (or an engaging arm). Two engaging arms 32 (or two engaging slots) flank the mounting unit 3 laterally. The engaging arms 32 engage with the engaging slots 231, respectively, such that the mounting unit 3 is fixed to the casing 2 from behind to therefore abut against the conductive pin structures 11, 12, thereby allowing the conductive pin structures 11, 12 to be firmly disposed in the casing 2.

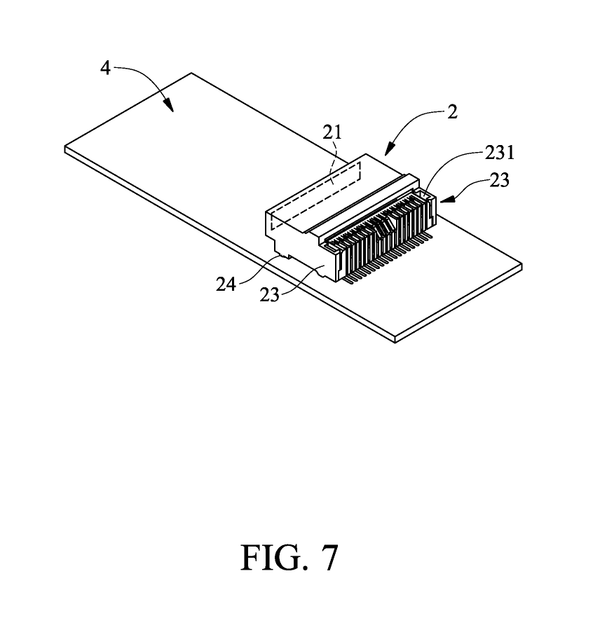

Referring to FIG. 1, FIG. 3, FIG. 5, FIG. 6, and FIG. 7, two mounting portions 24 are disposed at the bottom of the casing 2 of the electrical connector. The mounting portions 24, which come in the form of mounting posts, are inserted into two fixing holes 42 of the circuit board 4, respectively, such that the electrical connector of the present invention can be connected to the circuit board 4.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A conductive pin structure, comprising:
a frame; and
a plurality of conductive pins arranged transversely, spaced apart, disposed on two sides of the frame longitudinally, insertedly, and fixedly, passing through a hollow-core region of the frame, and each having a resilient electrical contact segment and an electrical connection segment connected to the resilient electrical contact segment.

2. The conductive pin structure of claim 1, wherein a connection portion is disposed on one of two open sides of the frame.

3. The conductive pin structure of claim 2, wherein the connection portion has a plurality of connecting posts or a plurality of connecting slots.

4. The conductive pin structure of claim 1, wherein the frame is disposed at the resilient electrical contact segments or the electrical connection segments.

5. The conductive pin structure of claim 1, wherein the frame is rectangular, and the conductive pins are longitudinally, insertedly, and fixedly disposed on two long sides of the frame and pass through a hollow-core region of the frame.

6. An electrical connector, comprising:
the two conductive pin structures of claim 1, wherein the frames are connected to each other; and
a casing having a forward-facing plug inlet and receiving the conductive pin structures, wherein the resilient electrical contact segments of the conductive pin structures point at the plug inlet, wherein terminal portions of the electrical connection segments of the conductive pin structures are exposed from the casing.

7. The electrical connector of claim 6, further comprising a mounting unit having a plurality of slits arranged transversely, spaced apart, and adapted to receive the electrical connection segments of the conductive pin structures, respectively, wherein the mounting unit is mounted on the casing from behind, wherein terminal portions of the electrical connection segments of the conductive pin structures are exposed from the mounting unit.

8. The electrical connector of claim 7, wherein two supporters flank the casing laterally and from behind, the supporters each having an engaging slot, wherein two engaging arms flank the mounting unit laterally and engage with the engaging slots, respectively, such that the mounting unit is fixed to the casing from behind.

9. The electrical connector of claim 7, wherein two supporters flank the casing laterally and from behind, the supporters each having an engaging arm, wherein two engaging slots flank the mounting unit laterally and engage with the engaging arms, respectively, such that the mounting unit is fixed to the casing from behind.

10. The electrical connector of claim 6, wherein a mounting portion is disposed at a bottom of the casing.
